(19) United States
(12) Patent Application Publication
(10) Pub. No.: US 2014/0165104 A1
(43) Pub. Date: Jun. 12, 2014

(54) DISPLAY APPARATUS AND INFORMATION PROVIDING METHOD USING DISPLAY APPARATUS

(71) Applicant: Samsung Electronics Co., Ltd., Suwon-si (KR)

(72) Inventors: Young-ho CHOI, Suwon-si (KR); Dae-hyun Nam, Anyang-si (KR); Tae-je Park, Suwon-si (KR)

(73) Assignee: Samsung Electronics Co., Ltd., Suwon-si (KR)

(21) Appl. No.: 13/946,518

(22) Filed: Jul. 19, 2013

(30) Foreign Application Priority Data
Dec. 6, 2012 (KR) 10-2012-0141357

(51) Int. Cl. H04N 5/445; H04N 21/431

(52) U.S. Cl. CPC H04N 5/445; H04N 21/431
USPC 725/40

(57) ABSTRACT

A display apparatus may include a display unit; an image receiver which receives an image signal; an image processor which processes an image to be displayed on the display unit; a user input unit which receives a user's input; and a controller which displays on the display unit a channel list comprising an image corresponding to a plurality of channels and is used to select the plurality of channels, and upon receiving a channel selection command from a user through the channel list, displays on the display unit additional information code corresponding to the selected channel together with the image corresponding to the selected channel.

### CROSS-REFERENCE TO RELATED APPLICATIONS

This application claims the priority benefit from Korean Patent Application No. 10-2012-0141357, filed on Dec. 6, 2012 in the Korean Intellectual Property Office, the disclosure of which is incorporated herein by reference.

### BACKGROUND

1. Field

Embodiments relate to a display apparatus and an information providing method using the display apparatus.

2. Description of the Related Art

A TV receives and processes an image signal corresponding to a channel selected by a user among image signals transmitted by a broadcasting station. ATV displays an image on a display panel based on the processed image signal. In addition to the aforementioned typical function, recent TVs may execute various functions such as launching of applications and Internet search, etc. and may perform e-commerce function via its TV system.

To perform the e-commerce through the TV system, a TV manufacturer and a service provider enter into a separate agreement under which TVs are manufactured to support the e-commerce function. Further, definitions including a mutual communication protocol should be established and other complicated development processes are required.

Utilization and widespread use of smart phones in recent years have encouraged provision of services combining functions of smart phones and TVs. In this application, the TV combining its functions with those of the smart phone is provided to overcome problems arising from e-commerce performed through the TV, and a method for conveniently obtaining information of a broadcast viewed by a user by using the TV and smart phone is provided.

### SUMMARY

Accordingly, one or more embodiments provide a service which enables a user to easily obtain information relating to a viewed broadcasting through a display apparatus and a user terminal.

In an aspect of one or more embodiments, there is provided a display apparatus including: a display unit; an image receiver which receives an image signal; an image processor which processes an image to be displayed on the display unit; a user input unit which receives input from a user; and a controller which displays on the display unit a channel list comprising an image corresponding to a plurality of channels and is used to select the plurality of channels, and upon receiving a channel selection command from a user through the channel list, displays on the display unit additional information code corresponding to the selected channel together with the image corresponding to the selected channel.

The additional information code may include a quick response (QR) code.

The controller may enlarge and display the selected QR code if a command for enlarging the displayed QR code is received by the user input unit.

The controller may control the enlarged QR code to overlap at least a part of the image corresponding to the selected channel when displayed.

The controller may control the display unit to display thereon the image of the selected channel if a command for displaying the selected channel is received by the user input unit.

The QR code may be received together with the image signal by the image receiver.

The display apparatus may further include a communication unit which communicates with a content server, wherein the QR code may be transmitted by the content server through the communication unit.

The controller may generate a QR code based on the additional information that has been transmitted together with the image signal, if the QR code is not received through the communication unit corresponding to the selected channel.

The user input unit may include an additional key to select displaying of the QR code.

The controller may transmit the QR code, which corresponds to the selected channel, to a preset portable terminal.

In an aspect of one or more embodiments, there is provided an information providing method using a display apparatus, the method including: displaying a channel list comprising an image corresponding to a plurality of channels and used for selecting the plurality of channels; receiving a channel selection command from a user through the channel list; and displaying an additional information code corresponding to the selected channel together with the image corresponding to the selected channel.

The additional information code may include a quick response (QR) code.

The method may further include receiving a command for enlarging the displayed QR code; and enlarging and displaying the selected QR code.

The enlarging and displaying the QR code may include overlapping and displaying the QR code to at least a part of the image corresponding to the selected channel.

The method may further include receiving a command for displaying the selected channel; and displaying an image of the displayed channel.

The QR code may be received together with an image signal that is received through the display apparatus.

The display apparatus may communicate with a content server, and the QR code may be transmitted by the content server.

The method may further include generating a QR code based on additional information that is received together with an image signal if the QR code is not transmitted by the content server corresponding to the selected channel.

The method may further include transmitting the QR code corresponding to the selected channel, to a preset portable terminal.

In an aspect of one or more embodiments, there is provided a display apparatus including a display unit; a user input unit which receives input from a user; and a controller which displays on the display unit a channel list comprising an image corresponding to a plurality of channels for channel selection, and wherein upon receiving a channel selection command from a user through the displayed channel list, the controller displays on the display unit an additional information code corresponding to the selected channel together with the image corresponding to the selected channel.

### BRIEF DESCRIPTION OF THE DRAWINGS

The above and/or other aspects will become apparent and more readily appreciated from the following description of embodiments, taken in conjunction with the accompanying drawings, in which:

FIG. 1 is a control block diagram of a display apparatus according to an embodiment;

FIGS. 2 to 4 illustrate types of a channel list and additional information code displayed according to an embodiment; and

FIG. 5 is a flowchart of an information providing method using the display apparatus according to an embodiment.

### DETAILED DESCRIPTION

Below, embodiments will be described in detail with reference to accompanying drawings so as to be easily realized by a person having ordinary knowledge in the art. Embodiments may be embodied in various forms without being limited to embodiments set forth herein. Descriptions of well-known parts are omitted for clarity, and like reference numerals refer to like elements throughout.

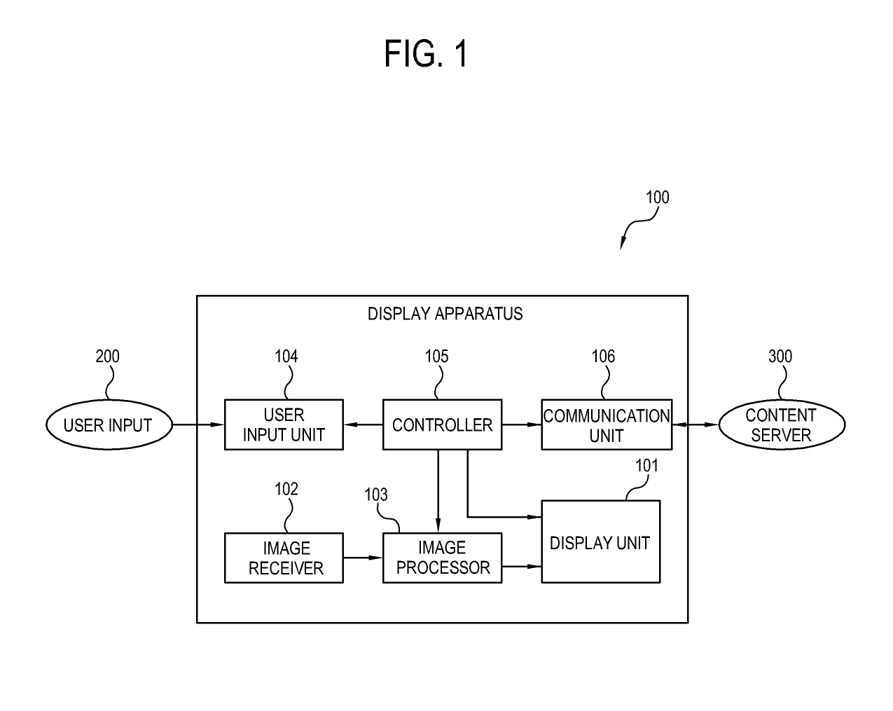

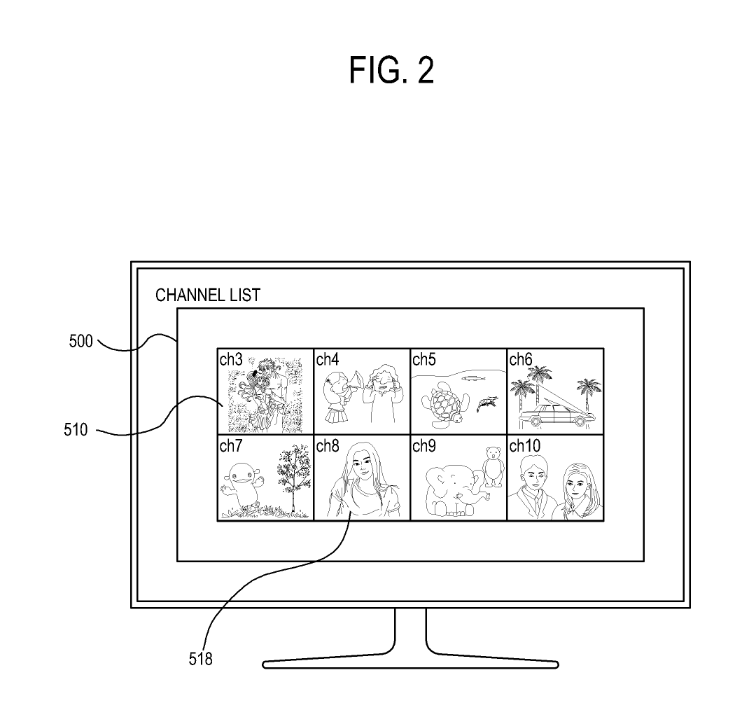

Hereinafter, characteristics of each element of a display apparatus according to an embodiment will be described in detail with reference to FIG. 1, and with reference to FIGS. 2 to 4 as necessary.

FIG. 1 is a control block diagram of a display apparatus 100 according to an embodiment.

As shown therein, the display apparatus 100 according to an embodiment includes a display unit 101, an image receiver 102, an image processor 103, a user input unit 104, a controller 105 and a communication unit 106. The display apparatus 100 may be implemented as a digital television (DTV), but the display apparatus is not limited thereto.

The display unit 101 displays an image thereon according to a control of the controller 105 (to be described later). The image displayed on the display unit 101 may include an image based on an input broadcasting signal, an image based on the image input by a connected external image source and a channel list used for selecting a broadcasting channel (to be described later). The display unit 101 may include, but is not limited to, a liquid crystal display (LCD), a plasma display panel (PDP), a light emitting diode (LED), organic light emitting diode (OLED), etc. and may further include other publicly known elements to display an image as necessary.

The image receiver 102 receives an image signal. In particular, the image signal may include analog or digital broadcasting signals transmitted by cable, satellite, or terrestrial and other broadcasting signal transmitting apparatuses, and may be received by channel according to a frequency band. The image receiver 102 may include a tuner to tune the image signal by channel. According to an embodiment, the image receiver 102 may receive image data packet from a server (not shown) through a network.

The image processor 103 processes an image to be displayed on the display unit 101. The image processor 103 may process a graphic image including a channel list (to be described later) as well as processing the broadcasting signal transmitted by the image receiver 102. The image of the broadcasting signal and the graphic image may be generated as separate layers, and the image processor 103 may include an additional hardware or software chip to process the image of the broadcasting signal and graphic image including the channel list. The image processing operation of the image processor 103 may include, but is not limited to, a decoding operation, a de-interlacing operation, a scaling operation, a noise reduction operation, and a detail enhancement operation. The image processor 103 may be implemented as a system on chip (SOC) which integrates the foregoing functions, or as an image processing board which is formed by installing individual elements performing the foregoing functions on a printed circuit board (PCB).

The user input unit 104 receives a user input 200. A representative example of the user input 200 performed through the user input unit 104 includes selection of channel, adjustment of volume, power on-off, and according to an embodiment, may include a channel selection command through the channel list, a command for enlarging a displayed quick response (QR) code and a command for displaying the selected channel. An embodiment example of the user input unit 104 may include a wireless communication module which receives a signal from a remote controller in a publicly known wireless manner such as infrared (IR), Bluetooth and Zigbee. According to an embodiment, the user input unit 104 may include a plurality of keys provided in an outer surface of the display apparatus 100. The user input unit 104 may include a plurality of keys, in which case, it may include at least one key to select the display or enlargement of the QR code displayed on the display unit 101 (to be described later).

The controller 105 controls respective elements of the display apparatus 100 according to an embodiment, and may include microprocessors such as a central processing unit (CPU) and a micro control unit (MCU).

If a user inputs a predetermined command through the user input unit 104 to change a channel, the controller 105 generates a channel list for selecting a plurality of channels corresponding to the predetermined command, and controls the display unit 101 to display the channel list thereon. The channel list may be implemented as various types of graphic user interfaces (GUIs) to select respective channels.

As shown in FIG. 2, a representative example of the channel list 500 according to an embodiment may include images, such as image 510 or 518 corresponding to the plurality of channels. This enables the user to select an interesting channel after viewing the representative image of channels instead of directly selecting a broadcasting channel number as in a conventional GUI for selecting channels. If the user selects the channel, the display apparatus 100 tunes the selected channel. The displayed image is an image that representatively describes a current program broadcast in each channel, and delivers information for the user to intuitively know what content will be broadcast. The image corresponding to the respective channels may be received by being included in electronic program guide (EPG) information included in an image signal transmitted from a broadcasting station, or received from a content server 300 connected to the communication unit 106 (to be described later) through a network. There is no restriction on the method of receiving the image. In an embodiment for transmitting the image from the content server 300, the content server 300 may transmit the image to the display apparatus 100 by directly acquiring such image from a broadcasting station or a copyright holder of a program, or by capturing a representative image from the program through a predetermined algorithm. There is no restriction on a method of generating the image by the content server 300.

If the channel list is displayed on the display unit 101, the user may select a particular channel through a remote controller or a key from the user input unit 104. Upon receiving an input for selecting a channel from the user through the channel list using the user input unit 104, the controller 105 controls the display unit 101 to display thereon an additional information code corresponding to the selected channel. If the input for selecting the channel is received, the controller 105 may immediately tune the image signal of the selected channel and display the image signal on the display unit 101 rather than displaying the additional information code. In this case, whether to display the additional information code may be set by the user in advance or selected at the time of displaying the channel list. Otherwise, the user input unit 104 may include a key for the user to change a channel or select displaying of additional information code corresponding to the selected channel and the user may select whether to display the additional information code through the key.

The additional information code expresses text information in a 2D image according to a preset protocol. The additional information code may be scanned by a scanning and reading device to identify the text information included in the additional information code. The additional information code may include information corresponding to the channel, e.g., may include brief information of a viewed program, a uniform resource locator (URL) address of the website of a broadcasting station or a program production company, and a URL address of the website providing related content information, and URL address of the website for products introduced by the channel to use e-commerce. If the additional information code is displayed on the display unit 101, the user may scan the additional information code by using a portable terminal (smart phone, PDA, etc.), other than the display apparatus 100, having functions of scanning and reading the additional information code. The portable terminal may read the additional information code and provide the user with information included in the additional information code or directly move to the URL.

An embodiment of the additional information code is not limited, and a representative example thereof includes a quick response (QR) code. The QR code consists of a 2D image in a rectangular shape, and may include far more information than conventional barcodes, and thus is widely used recently due to its strengths in restoration of errors and recognition ratio.

The display apparatus 100 according to an embodiment displays the additional information code corresponding to the selected channel through the channel list, and the user may scan the additional information code through an additional portable terminal to obtain the information. As a result, the portable terminal and the display apparatus 100 may promptly exchange information without any additional communication.

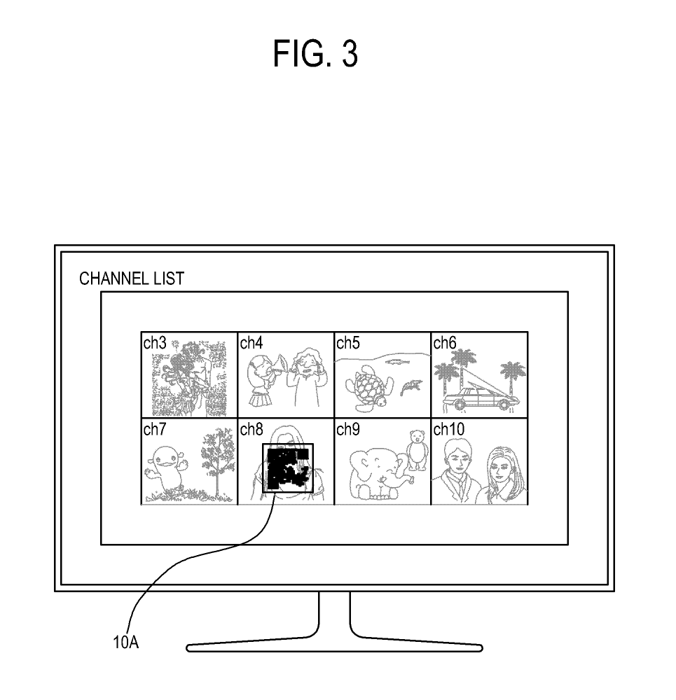

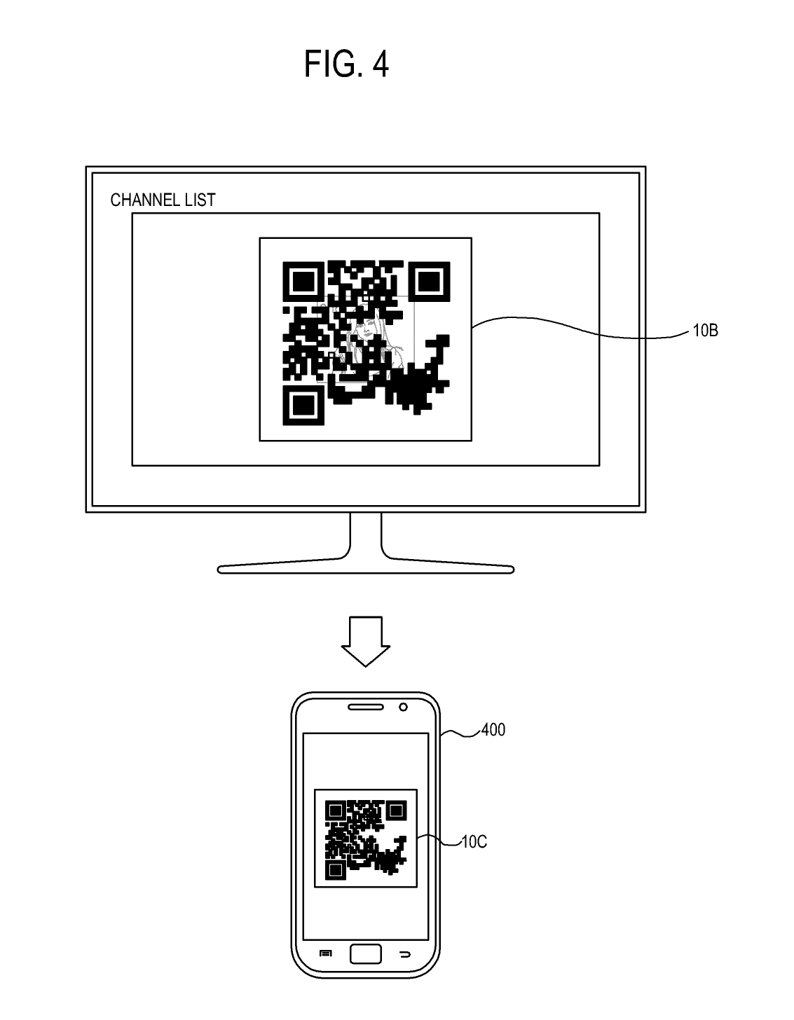

If the user desires to scan the QR code displayed, through the portable terminal, the QR code may not be scanned due to its small size. If the QR code is displayed in a larger size initially to prevent such problem, other information of the channel list may be covered by the larger QR code. Accordingly, upon initial selection of a channel, the controller 105 may display a QR code in a smaller size corresponding to a selected channel number 8 as shown in FIG. 3 (10A). If the user selects enlargement of the QR code through a remote controller, i.e., the command for enlarging the QR code is received by the user input unit 104, the QR code may be enlarged and displayed to be recognized more easily as shown in FIG. 4 (10B). The QR code may overlap at least a part of the image corresponding to the selected channel. The user may scan the enlarged QR code through the portable terminal 400 (10C) and conveniently obtain information included in the QR code. According to an embodiment, when a QR code is displayed in a smaller size as shown in FIG. 3 (10A), if a command for displaying the selected channel is received by the user input unit 104, the process of enlarging and displaying the QR code may be skipped, and the image of the selected channel may be promptly displayed on the display unit 101.

Various embodiments for receiving the QR code may be provided.

First, the image receiver 102 may receive QR code information together with an image signal. Generally, a digital image signal transmitted by a broadcasting station includes a transport stream (TS) consecutively transmitted by packet, and a payload of the received TS packet may include various additional information as well as video/audio signals. Accordingly, the additional information may include QR code information, in which case, the additional information may include only information of a 2D image of the QR code rather than text information included in the QR code. The image signal received by the image receiver 102 may be separated into respective data by a demultiplexer, and the controller 105 displays the QR code on the display unit 101 by using the QR code information. However, according to the embodiment, a data standard of an image signal transmitted by a broadcasting station, e.g., information included in a header should be changed, and this is not easy to do in the current system where broadcasting data are defined and transmitted according to predefined standard.

Unlike the first case above, the QR code may be transmitted by an additional content server 300. The content server 300 may transmit various information, including a representative image of the channel, to the display apparatus 100 separately from the broadcasting signal transmitted by a broadcasting station, and may include a server provided by a manufacturer of the display apparatus 100 or a server to which the display apparatus 100 may be connected through an additional license. To communicate with the content server 300, the display apparatus 100 may include a communication unit 106 to be connected to a network in a wired/wireless manner.

If the display apparatus 100 may not receive the QR code, the controller 105 may generate the QR code on its own and display the QR code on the display unit 101. As explained above, the QR code expresses text information in a 2D image, and is generated by a certain protocol. The received image signal may include additional information, which may include text information such as URL information. Accordingly, the controller 105 may generate the QR code based on the additional information that has been received according to a predetermined algorithm under QR code generating rule.

The user may recognize the displayed QR code through an additional portable terminal and obtain information included in the QR code. However, there may be a case where the displayed QR code may not be accurately recognized due to the lack of a camera function of the portable terminal that the user carries. To be prepared for such case, the controller may transmit the QR code information to the portable terminal. In this case, the controller 105 may transmit the QR code information in a form of multimedia messaging system (MMS) to a base station through a mobile communication network.

Otherwise, the display apparatus 100 may read the QR code on its own through additional software for reading the QR code. In this case, the read information may be displayed on the display unit 101 or transmitted to the portable terminal.

The display apparatus 100 according to the embodiment may provide a service through which the user may easily obtain information related to a viewed broadcasting using a portable terminal, without direct communication with the portable terminal.

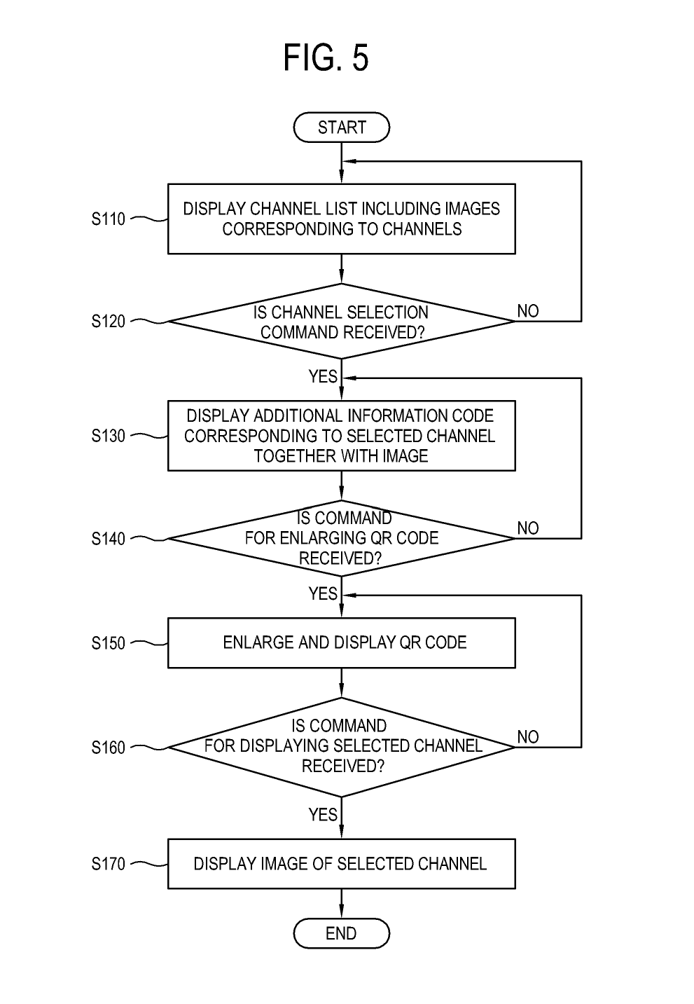

Hereinafter, characteristics of an information providing method using the display apparatus 100 according to an embodiment will be described with reference to FIG. 5. Repetitive description which is identical to that described with reference to FIGS. 1 to 4 will be omitted.

FIG. 5 is a flowchart of an information providing method using the display apparatus 100 according to an embodiment.

The display apparatus 100 according to an embodiment may be implemented as a DTV which may process an image signal and display an image on the display panel, but not limited thereto.

If a predetermined command is input to change a channel by the user, the display apparatus 100 generates and displays a channel list for the user to select a plurality of channels (S110). The channel list may be implemented as various types of GUIs for selecting respective channels. In particular, the channel list according to an embodiment may include an image corresponding to the plurality of channels as shown in FIG. 2.

While the channel list is displayed, the user selects a particular channel through a remote controller or a key from an external surface of the display apparatus 100, and the display apparatus 100 receives a command from the user for selecting the channel through the channel list (S120).

If a command is transmitted by the user to select the channel, the additional information code corresponding to the selected channel is displayed together with the image corresponding to the channel (S130). The additional information code expresses text information in a 2D image according to a preset protocol. If the additional information code is scanned by a portable terminal scanning and reading the additional information code, the text information included in the additional information code may be identified. The portable terminal may read the additional information code and provide the user with information included in the additional information code or directly move to the URL. An embodiment of the additional information code may include, but is not limited to, QR code.

The additional information code, (e.g., the QR code) may be displayed in a smaller size in a part of the channel list as shown in FIG. 3. The display apparatus 100 may receive a command from the user to enlarge the QR code (S140), and upon selection of the QR code, the display apparatus 100 enlarges and displays the QR code (S150). The QR code may overlap at least a part of the image corresponding to the selected channel as shown in FIG. 3. As the QR code is displayed in an enlarged size, the user may easily scan the enlarged QR code through the portable terminal.

If a command for displaying an image is received while the QR code is displayed (S160), the image of the selected channel may be displayed on the display apparatus (S170).

If the enlargement of the QR code (S150) is skipped and the QR code is displayed together with the image (S130), upon receiving a command from the user to display the image, i.e., the image corresponding to the selected channel may be displayed promptly. That is, operations S140 and S150 may be skipped in FIG. 5.

Various embodiments for receiving the QR code may be provided. For example, the QR code information may be included in the additional information transmitted together with the image signal, or the QR code may be transmitted by the content server 300 communicating with the display apparatus 100 through a network. This has been described above in detail.

If the display apparatus 100 does not receive the QR code, the display apparatus 100 may generate and display the QR code according to a predetermined algorithm under the QR code generating rule, based on the received additional information.

As the user may not accurately recognize the QR code due to lack of a camera function of his/her portable terminal, the display apparatus 100 may transmit the QR code information to the portable terminal, or may recognize the QR code on its own through additional software and display the QR code.

An information providing method using the display apparatus 100 according to an embodiment may provide a service through which the user may easily obtain information relating to a viewed broadcasting by using the portable terminal.

As described above, according to an embodiment, the display apparatus and an information providing method using the display apparatus may provide a service through which the user may easily obtain information relating to a viewed broadcasting through the display apparatus and a user's terminal.

Although a few embodiments have been shown and described, it will be appreciated by those skilled in the art that changes may be made in these embodiments without departing from the principles and spirit of the disclosure, the range of which is defined in the appended claims and their equivalents.

What is claimed is:

1. A display apparatus comprising:
a display unit;
an image receiver which receives an image signal;
an image processor which processes an image to be displayed on the display unit;
a user input unit which receives input from a user; and
a controller which displays on the display unit a channel list comprising an image corresponding to a plurality of channels for channel selection, and
wherein upon receiving a channel selection command from a user through the displayed channel list, the controller displays on the display unit an additional information code corresponding to the selected channel together with the image corresponding to the selected channel.

2. The display apparatus according to claim 1, wherein the additional information code comprises a quick response (QR) code.

3. The display apparatus according to claim 2, wherein the controller enlarges and displays the selected QR code if a command for enlarging the displayed QR code is received by the user input unit.

4. The display apparatus according to claim 3, wherein the controller controls the enlarged QR code to overlap at least a part of the image corresponding to the selected channel when displayed.

5. The display apparatus according to claim 3, wherein the controller controls the display unit to display thereon the image of the selected channel if a command for displaying the selected channel is received by the user input unit.

6. The display apparatus according to claim 3, wherein the QR code is received together with the image signal by the image receiver.

7. The display apparatus according to claim 2, further comprising a communication unit which communicates with a content server, wherein the QR code is transmitted by the content server through the communication unit.

8. The display apparatus according to claim 7, wherein the controller generates a QR code based on the additional information that has been transmitted together with the image signal, if the QR code is not received through the communication unit corresponding to the selected channel.

9. The display apparatus according to claim 2, wherein the user input unit comprises an additional key to select displaying of the QR code.

10. The display apparatus according to claim 2, wherein the controller transmits the QR code, which corresponds to the selected channel, to a preset portable terminal.

11. An information providing method using a display apparatus, the method comprising:
displaying a channel list including an image corresponding to a plurality of channels for channel selection;
receiving a channel selection command from a user through the channel list; and
displaying an additional information code corresponding to the selected channel together with the image corresponding to the selected channel.

12. The method according to claim 11, wherein the additional information code comprises a quick response (QR) code.

13. The method according to claim 12, further comprising:
receiving a command for enlarging the displayed QR code; and
enlarging and displaying the selected QR code.

14. The method according to claim 13, wherein the enlarging and displaying the QR code includes overlapping and displaying the QR code to at least a part of the image corresponding to the selected channel.

15. The method according to claim 13, further comprising:
receiving a command for displaying the selected channel; and
displaying an image of the displayed channel.

16. The method according to claim 12, wherein the QR code is received together with an image signal that is received through the display apparatus.

17. The method according to claim 12, wherein the display apparatus communicates with a content server, and the QR code is transmitted by the content server.

18. The method according to claim 17, further comprising generating a QR code based on additional information that is received together with an image signal if the QR code is not transmitted by the content server corresponding to the selected channel.

19. The method according to claim 12, further comprising transmitting the QR code corresponding to the selected channel, to a preset portable terminal.

20. A display apparatus comprising:
a display unit;
a user input unit which receives input from a user; and
a controller which displays on the display unit a channel list comprising an image corresponding to a plurality of channels for channel selection, and
wherein upon receiving a channel selection command from a user through the displayed channel list, the controller displays on the display unit an additional information code corresponding to the selected channel together with the image corresponding to the selected channel.
